(19) United States
(12) Patent Application Publication
(10) Pub. No.: US 2015/0053031 A1
(43) Pub. Date: Feb. 26, 2015

(54) SCISSOR GEAR WITH HYDRAULIC BACKLASH REMOVAL AND HYDRAULIC TORSIONAL DAMPING

(71) Applicant: Pinnacle Engines, Inc., San Carlos, CA (US)

(72) Inventors: Michael A. Willcox, Redwood City, CA (US); James M. Cleeves, Redwood City, CA (US); Dimitri Bassis, Menlo Park, CA (US); Kyle Langlands, San Mateo, CA (US)

(21) Appl. No.: 14/465,749

(22) Filed: Aug. 21, 2014

Related U.S. Application Data
(60) Provisional application No. 61/871,265, filed on Aug. 28, 2013.
(60) Provisional application No. 61/868,511, filed on Aug. 21, 2013.

(51) Int. Cl. F16H 57/12; F16H 1/20

(52) U.S. Cl. CPC F16H 57/12; F16H 1/20; F16H 2057/123; F16H 2057/127
USPC 74/409

(57) ABSTRACT

A gear assembly can include a biasing apparatus, which can include a hydraulic biasing member. The biasing apparatus can be activated to urge a scissor gear tooth of a scissor gear toward a second gear tooth of a second gear. The urging of the scissor gear tooth toward the second gear tooth can close a backlash gap between a first gear tooth of a first gear and the second gear tooth of the second gear.

### CROSS-REFERENCE TO RELATED APPLICATION

This application claims the benefit of priority under 35 U.S.C. §119(e) of U.S. Provisional Application Ser. No. 61/868,511, filed Aug. 21, 2013, titled, “Scissor Gear with Hydraulic Backlash Removal and Hydraulic Torsional Damping,” and U.S. Provisional Application Ser. No. 61/871,265, filed Aug. 28, 2013, titled, “Scissor Gear with Hydraulic Backlash Removal and Hydraulic Torsional Damping,” which are incorporated by reference herein in their entirety herein.

### TECHNICAL FIELD

The subject matter described herein relates to backlash adjusting and torsional damping, for example in gear trains of engines or other machinery.

### BACKGROUND

Backlash, which can also be referred to as lash or play, can be defined as a clearance or loss in motion in a mechanism that is caused by gaps between parts, such as between gears in a gear mesh or gear train (referred to generically herein as “a gear assembly”). For example, such as in the context of a gear mesh or gear train, backlash can be the amount of clearance between mated gear teeth. The backlash can be seen when the direction of movement between the gears in the gear train is reversed and the slack or motion (e.g., due to the clearance between the mated gear teeth) is taken up before the reversal of motion is complete.

### SUMMARY

Aspects of the current subject matter can include a gear assembly including a biasing apparatus as well as related methods that can involve the use of such an apparatus. In one aspect, a gear assembly includes a main gear having a first gear tooth of a plurality of first gear teeth and positioned to rotate about a first axis, a second gear having a second gear tooth of a plurality of second gear teeth and positioned to rotate about a second axis such that the plurality of second gear teeth mesh with the plurality of first gear teeth, and a scissor gear having a third gear tooth (e.g. a scissor gear tooth) of a plurality of third gear teeth (e.g. scissor gear teeth) and positioned to rotate about the first axis. The gear assembly further includes a biasing apparatus disposed to selectively urge the third gear tooth of the scissor gear toward the second gear tooth of the second gear such that the selectively urging includes a closing of a backlash gap between the first gear tooth and the second gear tooth when the biasing apparatus is actuated. The biasing apparatus can include a hydraulic biasing member.

In another aspect, a method includes actuating a hydraulic biasing member of a biasing apparatus disposed to act on a scissor gear that includes a third gear tooth of a plurality of third gear teeth and that is positioned to rotate about a first axis. The method further includes causing, as a result of the actuating, an urging of the third gear tooth toward a second gear tooth of a plurality of second gear teeth of a second gear, thereby closing a backlash gap between a first gear tooth of a plurality of first gear teeth of a main gear and the second gear tooth of the second gear. The main gear is positioned to rotate about the first axis and the second gear is positioned to rotate about a second axis.

In some variations, one or more of the following features can optionally be included in any feasible combination. A fluid pathway can be in fluid communication with the hydraulic biasing member, and actuation of the biasing apparatus can include increasing fluid pressure in the fluid pathway. The biasing apparatus can experience a second condition subsequent to being actuated, and the second condition can include a decrease in fluid pressure in the fluid pathway that allows opening of the backlash gap. A pressure adjusting element can be in communication with the fluid pathway, and the pressure adjusting element can cause the increase and subsequent decrease in fluid pressure in response to rotation of the scissor gear about the first axis. In addition, the selectively urging can occur when the gear assembly is under a negative load. Additionally, the hydraulic biasing member can include a piston. Furthermore, a spring can be positioned to assist with opening or closing the backlash gap between the first gear tooth and the second gear tooth. A lifter carrier having a fluid pathway can be in fluid communication with the hydraulic biasing member, and the biasing apparatus can be secured to the lifter carrier. The scissor gear can include a tab that extends through a gap in the main gear, and the tab can be positioned to allow the hydraulic biasing member to selectively urge against the tab. In addition, the selective urging of the biasing apparatus can be controlled by one or more of a static spring, an electronically controlled solenoid, and a cam apparatus. A second biasing apparatus can have a second hydraulic biasing member disposed to selectively urge a fourth gear tooth of a second scissor gear toward a fifth gear tooth of a third gear, with the selectively urging closing a backlash gap between the fourth gear tooth and the fifth gear tooth when the second biasing apparatus is activated. The biasing apparatus can be disposed to selectively urge a fourth gear tooth of a second scissor gear toward a fifth gear tooth of a third gear, with the biasing apparatus being actuated bi-directionally and the selectively urging closing a backlash gap between the fourth gear tooth and the fifth gear tooth when the biasing apparatus is actuated. The hydraulic biasing member can be oriented to apply a force in a direction approximately perpendicular to the first axis. Additionally, the second axis can be parallel to the first axis.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A shows a diagram of a gear assembly illustrating an example of gear backlash;

FIG. 1B shows a diagram illustrating an example of a gear assembly including a three-gear mesh or drive train consistent with implementations of the current subject matter;

FIG. 2 and FIG. 3 show cross sectional view of a hollow camshaft consistent with implementations of the current subject matter;

FIG. 4 shows an example of a hydraulic lash adjuster used in operation of a scissor gear;

FIG. 5A and FIG. 5B show graphs illustrating aspects of the hollow camshaft approach of FIG. 2 and FIG. 3;

FIG. 6, FIG. 7, and FIG. 8 shows views of a gear assembly consistent with implementations of the current subject matter;

FIG. 9 shows an example of a hydraulic lift adjuster element consistent with implementations of the current subject matter;

FIG. 10A an FIG. 10B show views of an example of another hydraulic lift adjuster element consistent with implementations of the current subject matter;

FIG. 11 shows a gear assembly having one or more features consistent with implementations of the current subject matter;

FIG. 12 shows an example of a fluid reservoir having one or more features consistent with implementations of the current subject matter;

FIG. 13 shows a process flow chart illustrating features of a method consistent with implementations of the current subject matter.

When practical, similar reference numbers denote similar structures, features, or elements.

### DETAILED DESCRIPTION

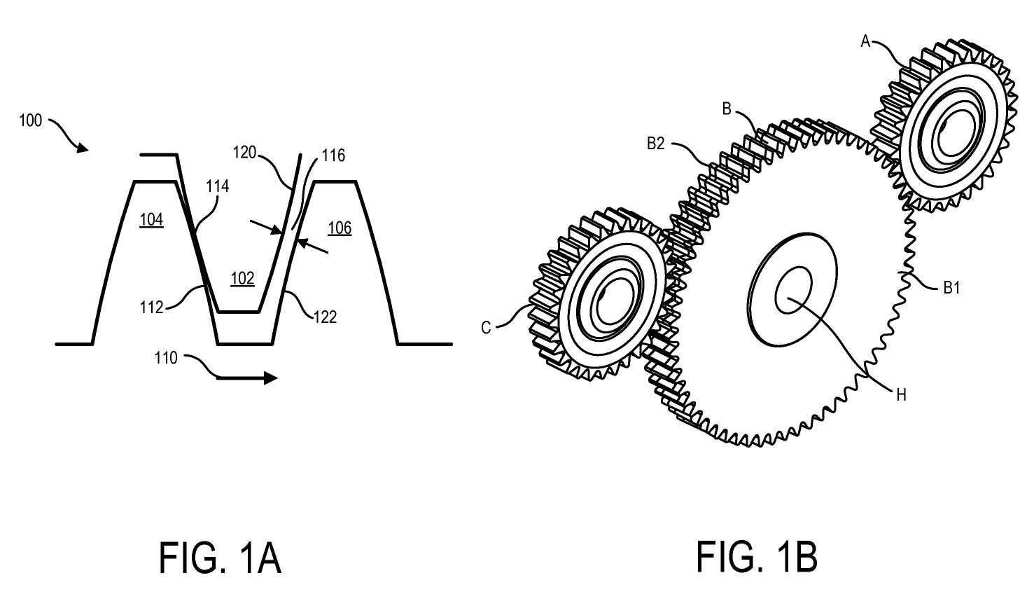

When using two or more gears as part of a gear train of a drive system or the like (e.g. a gear assembly, at least a small amount of backlash is typically employed to ensure that binding or jamming of the gear train does not occur during assembly or operation. In this context, backlash is the amount of clearance between mated gear teeth, an example of which is shown in the diagram shown in FIG. 1A of a gear assembly 100 illustrating teeth of two mated gears. As shown in FIG. 1A, a tooth 102 of the first (upper) gear mates between a first tooth 104 and a second tooth 106 of the second (lower) gear. Motion of the second gear in the direction of the dashed line 110 causes a front flank 112 of the first tooth 104 of the second gear to be urged against a front flank 114 of the tooth 102 of the first gear. The gap 116 between a back flank 120 of the tooth 102 of the first gear and a back flank 122 of the second tooth 106 of the second gear is the amount of backlash.

Depending on the direction of gear torque, the backlash spacing can be reversed. For example, driving torque of the second (lower) gear in a direction opposite to the dashed line 110 can cause the gap 116 in FIG. 1A to occur between the front flank 112 of the first tooth 104 of the second gear and the front flank 114 of the tooth 102 of the first gear. Reversal of the backlash gap 116 between opposing tooth flanks can result in an audible rattle or hammering sound due to the impact of the free-moving tooth flank into the mating gear.

This noise can be reduced or eliminated by adding an additional (typically relatively thin) gear to the gear assembly (e.g. a gear train or gear mesh). This gear, called a scissor gear, can be loaded in torsion, for example by action of a spring (either in torsion or compression) such that the scissor gear is forced against the driven flank of the drive gear (for example, the back flank 122 in FIG. 1). In this manner, positive loads on the gear train can be carried by front (positive load) flanks of a main or primary gear (e.g., between the front flank 112 of the first tooth 104 of the second gear and the front flank 114 of the tooth 102 of the first gear) while negative loads (provided they are less than a torsional preload of the scissor gear), can be passed by the back flank 122 into the scissor gear teeth, through the spring, and into the main gear's hub. Such a configuration can reduce noise due to reduction of backlash reversal severity by slowing the lash reversal event, or eliminate backlash entirely when the torque provided by the preloaded scissor gear assembly exceeds the negative drive torque level. If the reverse drive torque load exceeds the spring loading, gear backlash forms as the spring deflects, and the hammering or rattle can return, albeit generally with reduced severity as the spring absorbs at least some of the impact force between the reversing flanks. It will be understood that the terms “main” or “primary” as used herein in reference to a gear are intended to indicate that the main or primary gear has an associated scissor gear.

The main or primary gear in the examples discussed herein as well as in other implementations of the current subject matter can be included anywhere in a gear assembly, and need not be attached to an initial source of rotational torque. For example, in an internal combustion engine, the main or primary gear and one or more scissor gears rotating about a same axis with the main or primary gear can optionally be mounted to a crankshaft of the internal combustion engine. Alternatively or in addition, a main or primary gear can be mounted to another rotating shaft, such as for example a camshaft or other shaft. A gear assembly can optionally include a series of two or more gears operating directly on one another with tooth-to-tooth contact between all gears in the gear assembly. Alternatively or in addition, a gear assembly can include belts, chains, or other drive connections.

A potential disadvantage of spring-based scissor gear designs is that the additional load on the gear mesh due to the preload force of the scissor gear can result in increased friction and, in some cases, can also increase gear whine. To fully arrest backlash reversal, the scissor gear preload can exceed the peak negative load in the drive system. Where negative loads are small enough that scissor gear preloads can be minimized, such an approach can be successfully employed without large friction or noise impact in systems. However, in systems that have high negative loads, the preload must be increased and the resulting increased friction and noise (gear whine) can be undesirable.

Implementations of the current subject matter can include features relating to hydraulic backlash removal and hydraulic torsional damping. Approaches such as those described herein can be used for controlling and minimizing backlash associated with gear mechanisms.

A drive system consistent with implementations of the current subject matter can include hydraulic fluid for actuating a biasing apparatus which can include a hydraulic biasing member, such as either a conventional hydraulic lash adjusting element or a check-valved oil circuit that can allow low pressure oil to produce a low torsional preload on a scissor gear assembly. Throughout this disclosure, the terms hydraulic lash adjuster or hydraulic lash adjusting element are used in reference to specific implementations. However, it will be understood that other types of biasing apparatuses and hydraulic biasing members are also contemplated and within the scope of the current subject matter. A hydraulic lash adjusting element or check-valved oil circuit can be solely hydraulically preloaded via gallery pressure, or complimented with a spring providing a compressive or torsional force sized according to one or more factors, which can include available oil gallery pressure, time-to-fill from startup, friction, etc. Such a configuration can allow the preload on the system to be much lower than a traditional spring-based design by making the load carrying ability bi-directional. In other words, a reduced preload can be provided in the positive (clamping) scissor gear direction while providing the capability to carry a large negative load through a hydraulic load path without opening gear backlash. A reduced preload and high negative load ability can reduce friction and engine noise (e.g. gear whine) while also minimizing or eliminating lash reversal noise.

A hydraulic lash-adjusting element consistent with implementations of the current subject matter can be located on either drive or driven gear assemblies with attention paid to direction of travel. In addition, depending on the volume, supplied oil pressure, and the fill time for the hydraulic elements used in such structures, a lightly preloaded spring, which need not be capable of overcoming a significant portion of the negative load transmission, may be utilized. This lightly preloaded spring can be helpful in minimizing initial lash that exists until oil pressure is built. Additionally, pressure bleed-off features can be accounted for and can be built into the overall permissible leakage rate of the system such that rapid cool down does not result in system binding (e.g. via thermal contraction).

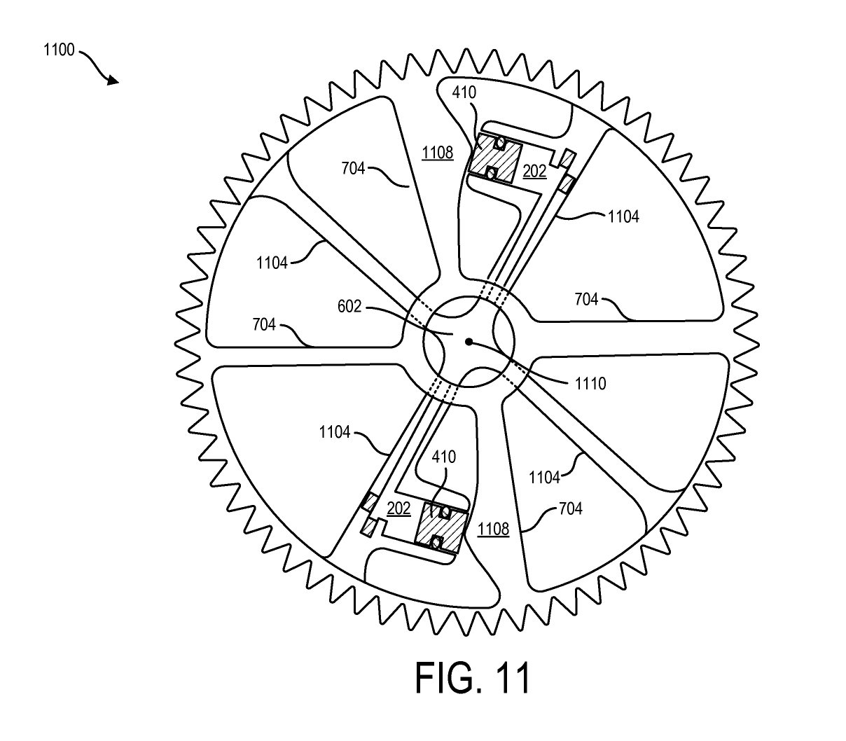

Deaeration of the system through a bleed can also be implemented to ensure the hydraulic volume does not store air that could lead to reduced hydraulic system stiffness. For example, dearation of the system can occur through a bleed positioned at an innermost rotational point of the gear. For example, a hydraulic path between the hydraulic lift adjuster (HLA) or piston 410 and the bleed hole 1110 can advantageously follow a path that monotonically approaches the center of the gear and the bleed hole 1110 as it moves from the HLA to the bleed hole 1110. Such a configuration can prevent or reduce trapping of air in the hydraulic path. Furthermore, the HLA or piston 410 can be oriented relative to the gears in a variety of different ways. For example, the HLA or piston 410 can be positioned perpendicular or at an angle relative to the axis of rotation (e.g., the first axis), such as shown in FIG. 11 and the axis of motion of the HLA or piston 410 can optionally be oriented approximately parallel to a tangent of the gears or at some other angle. Overly low hydraulic system stiffness can undesirably permit the negative torque to open backlash between the scissor gear and drive gears which can result in hammering or rattle noise.

Some implementations of the system can include a hydraulic lash adjuster or adjusters for valve train lash removal which can be mounted in the spokes of the gear and oriented approximately perpendicular to the axis of gear rotation. Engine oil pressure can be used to supply a hydraulic volume or reservoir with low pressure oil that causes the hydraulic lash adjuster to increase in length when unloaded. A one-way check valve can prevent reductions in length by preventing oil from exiting the system when loaded. The hydraulic lash adjuster or adjusters for valve train lash removal can be mounted such that linear growth translates into a rotational motion of the scissor gear until it is stopped in the negative drive flank of the teeth of a mating gear.

In some implementations, when positive load is being carried, the load path does not pass through the hydraulic element as it goes from the drive gear's positive drive tooth flank directly through to the driven gear's positive drive tooth flank. In addition, the system hydraulic pressure and preload can remain minimal, which can be determined by engine oil pressure. Additionally, when some negative loads need to be carried, the load path can go from the drive gear's driven flank, into the scissor gear, then into the hydraulic element, and then on to the drive gear's hub or one or more features which converts the hydraulic element's load to torque via a moment arm. Furthermore, one or more lash adjusters can be used at equal, or differing, radii from the rotational axis of the gear depending on, for example, the load (i.e., force) carrying capability of each unit, the distance away from the rotational axis they are mounted, the travel available, and a general goal of minimizing the fluid volume to reduce fill time (i.e., time to build sufficient pressure to eliminate lash). A balance can advantageously be struck between a mounting radius of the HLA 410 (e.g. a distance from the center of the gears) and a speed at which the gear runs. For example, a high speed gear with an HLA mounted near the rim (e.g. the outer edge of the gear at a relatively larger mounting radius) can experience high oil pressure due to the centrifugal force on the oil. This elevated oil pressure can increase the preloading of the gear and thereby also increase the friction. If the HLA is mounted at a smaller radius (e.g. closer to the hub), then centrifugal oil pressure changes are generally reduced or even minimized.

In some implementations in which more than two gears are in mesh, one or more hydraulic lash adjustment elements or pistons, etc. can be applied on a central gear in a drive train or gear mesh such that the one or more hydraulic lash adjustment elements or pistons transmit the negative torque or force directly from one scissor gear into another bypassing the central gear with which the two scissor gears are coaxially mounted. This arrangement can allow lash of at least two gear meshes to be eliminated with a single load path and can reduce the number of hydraulic elements required as well as the oil volume (i.e., time to fill) impact. As an example, a three gear mesh or drive train can include gears A-B-C, such as for example as illustrated in FIG. 1B. To provide for backlash adjustment, a pair of scissor gears, which are labeled as B1 and B2, respectively, for the purposes of this discussion though they are not shown in FIG. 1B, can be mounted to rotate concentrically (e.g. on a same axis) with gear B. The two scissor gears can advantageously be thin relative to the width of the main gears A, B, and C. One of the scissor gears (e.g. B1) is in mesh with gear A, while the second scissor gear (e.g. B2) is in mesh with gear C. For example, the scissor gears B1 and B2 and main gear B can rotate along a first axis, and gear A can rotate on a second axis that can be parallel or angled relative to the first axis. The main gear B is also in mesh with both gear A and gear C to form the drive train. One end of a hydraulic backlash adjustment element (not shown in FIG. 1B) can rest on a spoke or other structure of a first of the scissor gears B1 while the other end rests on a spoke or other structure of a second of the scissor gears B2, thereby bypassing the hub H of gear B. Fluid pressure in the hydraulic lash adjuster can force a separation directly between one scissor gear and another without any force exerted on gear B until the cumulative lash between gear A/scissor gear B1 and scissor gear B2/gear C is eliminated. Positive load transmission thereby occurs from gear A to gear B to gear C. The negative load transmission path is from gear A into scissor gear B1, through the hydraulic backlash adjuster into scissor gear B2, and then into gear C. This approach can provide a benefit in that the number of hydraulic lash adjustment elements or pistons can be reduced by approximately 50% by avoiding the requirement to put a hydraulic lash adjustment element or piston between scissor gear B1/gear B and then another hydraulic lash adjustment element or piston between gear B/scissor gear B2.

In some implementations, the fluid reservoir can be pressure-actuated on an angle-resolved basis by a cam mechanism or electronic solenoid, which can optionally be controlled by an electronic control unit (ECU) or other processor-based controller. Angle resolved pressure actuation can allow application of the force at the desired cam or crankshaft angle and relief of the force at other angles. Being able to apply the force at least approximately only when the reversing loads are applied can reduce friction in the system at all other times. The force can be applied when needed, so long as the rotational position of the system is at least approximately known with respect to time. In addition, the hydraulic pressure (and hence preload on the scissor gear assembly in the negative torque direction) can be actuated once or multiple times per revolution of the shaft. For example, the oil inlet to the hydraulic volume can enter through a one-way check valve that prevents fluid from exiting the system. The fluid volume can be sealed except for a pressure release valve (PRV) which can be sized such that the pressure achieved before the valve releases fluid is equal to, or greater than, the pressure required to transmit the highest negative load the system can experience. For example, with a fast-acting pressure sensor and solenoid valve, the regulation pressure can be electronically controlled on an angle-resolved basis to achieve a target pressure versus rotational angle profile to match a given (i.e., negative) torque versus angle profile required.

In some implementations, the fluid system can be connected to the scissor gears by a piston or vane-type system similar to typical camshaft phasers that permit torque transmission via hydraulic pressure. For example, the system can be maintained at low engine oil system pressure for the majority of the cycle. In addition, during these periods, a light torsional or linear spring can be utilized to pull the scissor gear out of mesh (opening backlash while positive torque is being transmitted) in order to further reduce sliding friction. Alternatively, a light spring can be used to preload the scissor gear against the mating gear, or supply system pressure can be used alone.

In some implementations, before a negative load event is anticipated, the cam or solenoid can be configured to force a piston into the hydraulic system, which can close any lash if separated by a spring, and drive the system pressure up to the PRV regulation pressure. The high pressure, which can be connected to the scissor gear through drillings or passages, can then act on a piston or system which can provide the necessary negative torque loading to stop lash reversal. After the load event is over, the cam or solenoid can relax and the system can refill via the check valve. In addition, some implementations of the system can be configured with a dual-scissor gear with a single hydraulic reservoir mechanism having multiple gears in mesh.

Furthermore, in some implementations, the hydraulic torque transmission path can be reversed in order to enable positive drive torque to be transmitted instead of negative drive torque. A system including a gear assembly as described herein can also be configured to be torsionally compliant (e.g., to enable angular travel between the drive system and driven system) using the fluid reservoir, such as, for example, with aeration, spring and piston, component flex, or other means. In addition, this configuration can at least enable the fluid volume to change or translate and affect an angular deflection between drive and driven shafts when loaded. Additionally, at least some torsional compliant elements use mechanical springs to react to torque and therefore can have fixed or stepped torque versus angle profiles in addition to a fixed damping element (e.g. a Bellville spring with a friction pad, or other similar structures).

In some implementations, the hydraulic fluid reservoir (or lash adjuster) can be oriented in the positive torque direction and can be hydraulically connected to a piston mounted such that a spring, electronic solenoid, or cam can vary the system's torsional stiffness (i.e., via air dilution, or hydraulic pressure modulation) based on, for example, a variety of conditions such as engine temperature, crank angle, etc. Additionally, fixed damping can be accomplished with a spring or disc, or hydraulic pressure can be utilized to impose a force against sliding components. Accordingly, damping can be increased with fluid pressure. The drive system in this instance is not limited to a gear and could be belt, chain, or other drive connection. Additionally, hydraulic passages can be configured for wet or dry drive systems depending on requirements.

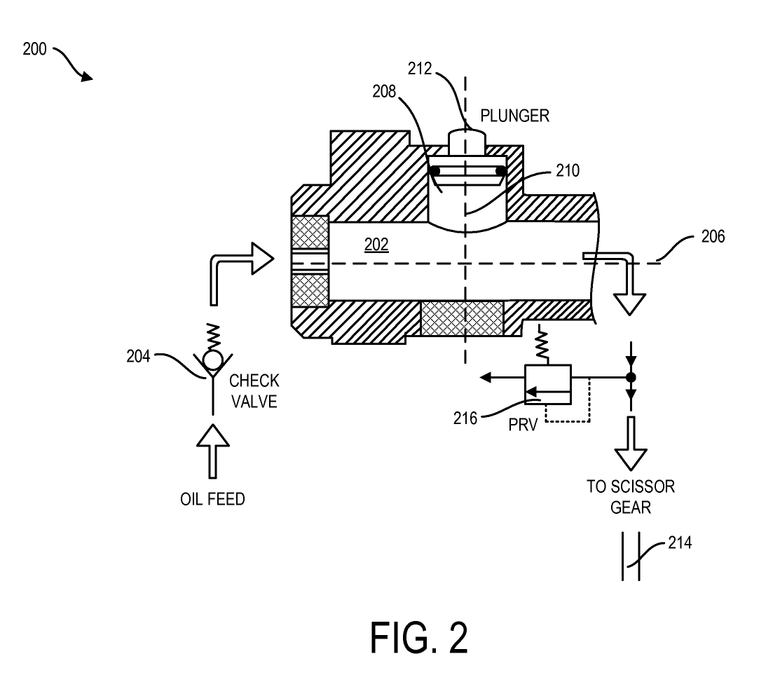

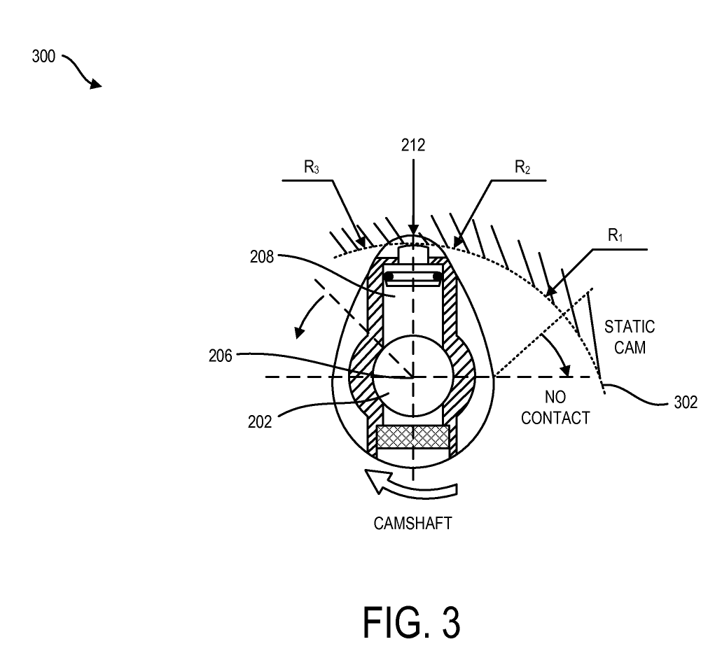

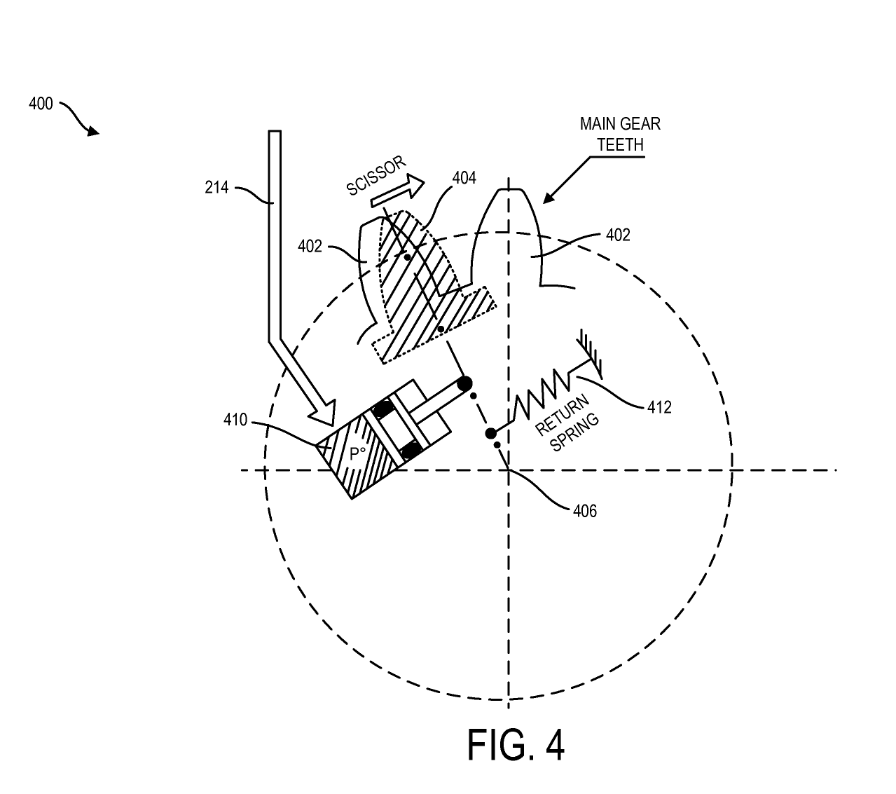

FIG. 2 shows a first cross-section view 200 of an example of a part of a hydraulic scissor gear control apparatus that includes a hollow shaft assembly. A fluid reservoir 202 within the hollow shaft assembly can receive a fluid, such as oil, through a check valve 204. The check valve 204 can assist in preventing backflow of the fluid, which can allow hydraulic pressure, created within the fluid reservoir 202, to be maintained. The fluid pathway can be part of a rotating eccentric shaft assembly, which rotates about an axis of rotation 206. A pressure adjusting element or plunger 208 can project away from the axis 206 and be moveable along a plunger axis 210, which can optionally be perpendicular to the axis of rotation 206. The plunger can include a contact tip 212 that is variably urged against a static cam structure 302 (shown in FIG. 3) as the rotating eccentric shaft assembly rotates about the axis of rotation 206. As the contact tip 212 of the plunger 208 is variably urged against the static shaft 302, motion of the plunger 208 along the plunger axis 210 is induced to increase or decrease the pressure in the fluid reservoir 202. Fluid in the fluid reservoir 202 can be in communication via one or more passages 214 (e.g. drillings, tubing, fluid passages, etc.) with a hydraulic lash adjustment element or piston 410 (shown in FIG. 4) that is associated with a scissor gear. A pressure release valve (PRV) 216 can assist in limiting the hydraulic pressure provided to the hydraulic lash adjustment or piston element 410. The pressure release valve can be controlled by one or more of a variety of different mechanisms. In some implementations of the current subject matter, the fluid volume in the hydraulic pressure system 200 can be sealed except for the PRV 216, which can be configured such that the pressure achieved before the PRV 216 releases fluid is equal to, or greater than, the pressure required to transmit the highest negative load the gear train is expected to experience.

FIG. 3 shows a cross sectional view 300 of the hydraulic pressure system shown in FIG. 2. The cross sectional view 300 is taken along the axis of rotation 206 of the fluid reservoir 202. As shown, rotation about the axis of rotation causes the contact tip 212 of the plunger 208 to be variably acted upon by a static cam 302. In addition, the hydraulic pressure, and hence the preloaded pressure on the scissor gear assembly in a negative torque direction, can be actuated once or multiple times per revolution of the shaft 302. The contact tip 212 and the reservoir 202 can optionally be located in one or more crankshafts, camshafts, or other shafts rotating at some ratio of engine speed.

FIG. 4 shows a cutaway schematic view of a gear assembly 400 that includes a main gear having main gear teeth 402 and a scissor gear having scissor gear teeth 404. Both of the main gear and the scissor gear are rotatable about a gear axis 406. Fluid from the hollow camshaft assembly shown in FIG. 2 and FIG. 3 can be provided via the one or more passages 214 to the hydraulic lash adjustment element or piston 410 for controlling movement of the scissor gear such that the teeth 404 of the scissor gear close the backlash gap 116 that would ordinarily exist between teeth of a second mating gear and the teeth 402 of the main gear shown in FIG. 4. As discussed previously, a return spring 412, which can be a light torsional or linear spring, can also provide a small preload bias to assist in movement of the scissor gear to close the backlash gap when the hydraulic pressure provided to the hydraulic lash adjustment element or piston 410 from the hollow camshaft assembly of FIG. 2 and FIG. 3 is not yet sufficient due to hydraulic delay.

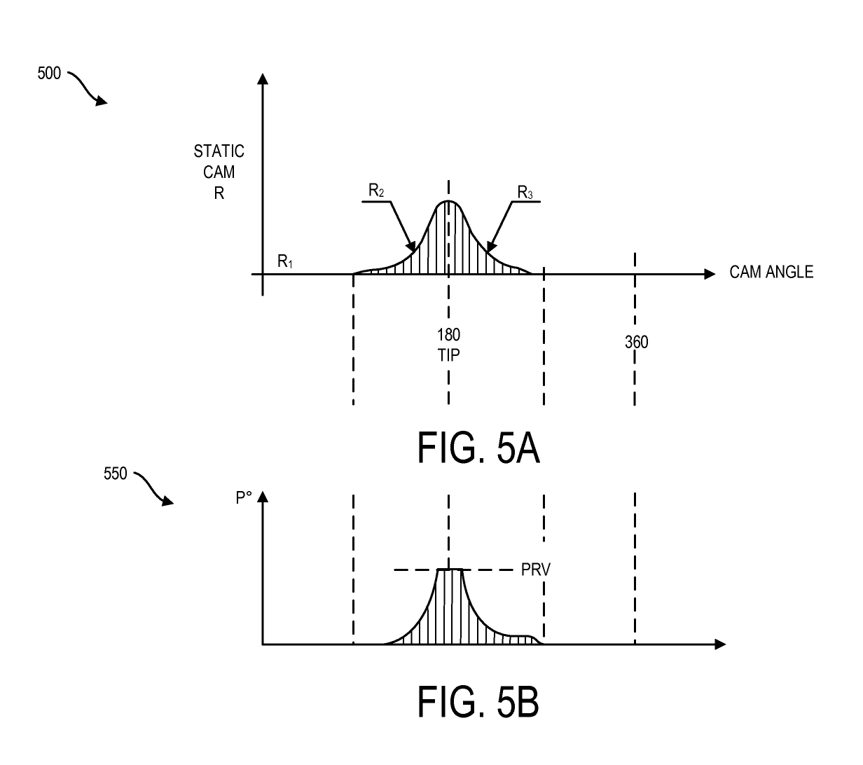

FIG. 5A and FIG. 5B show graphs 500 and 550. In FIG. 5A, the graph 500 illustrates the radius between the axis of rotation 206 and the contact tip 212 of the plunger 208 (as constrained by the static cam 302) as a function of the rotation angle of the hollow shaft assembly about the angle of rotation 206. In FIG. 5B, the graph 550 illustrates the pressure provided to the hydraulic lash adjustment element or piston 410 as controlled by the PRV as a function of angle of rotation of the hollow shaft assembly around the axis of rotation 206. As shown in the two graphs 500, 550, the static cam 302 does not contact the contact tip 212 of the plunger 208 except in a relatively narrow radius range. The maximum force on the contact tip 212 as a result of depression of the plunger 208 into the fluid in the fluid reservoir 202 occurs about the 180° angle of rotation and between two contact areas of radius R2 and R3, which are measured form the axis of rotation 206. In this region of maximum force on the contact tip and result maximum pressure exerted on the fluid in the fluid reservoir 202, the pressure, as shown in the graph 550 of FIG. 5B, is at a maximum. The pressure setting of the PRV 216 caps the maximum pressure to the desired level.

In this manner, rotation of the hollow shaft assembly shown in FIG. 2 and FIG. 3 create hydraulic pressure at a desired peak level to coincide with negative forces on the gear train and to thereby reduce the undesirable effects of backlash gap reversal, such as, for example, those discussed previously herein.

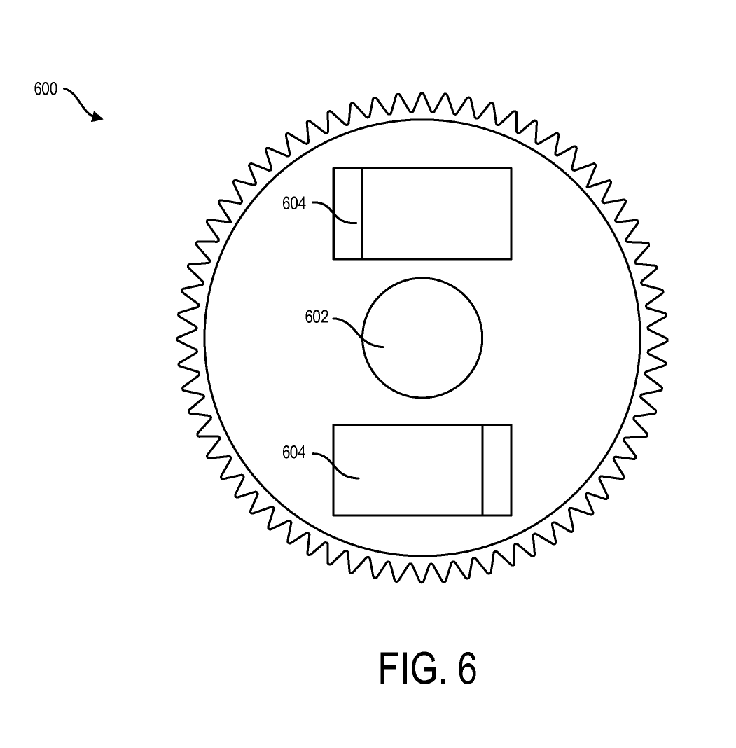

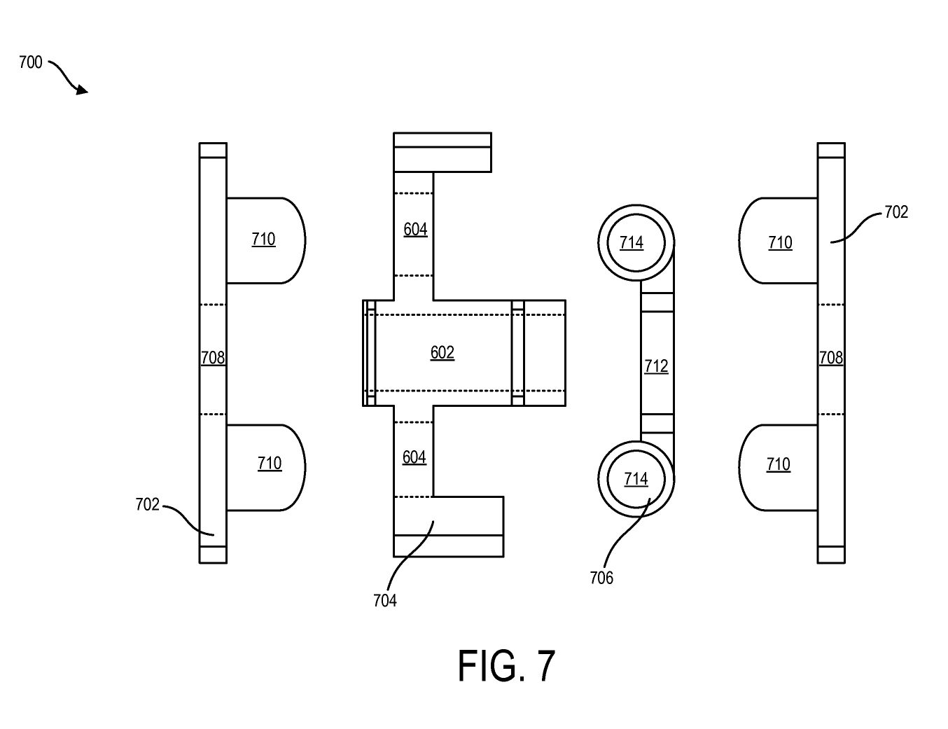

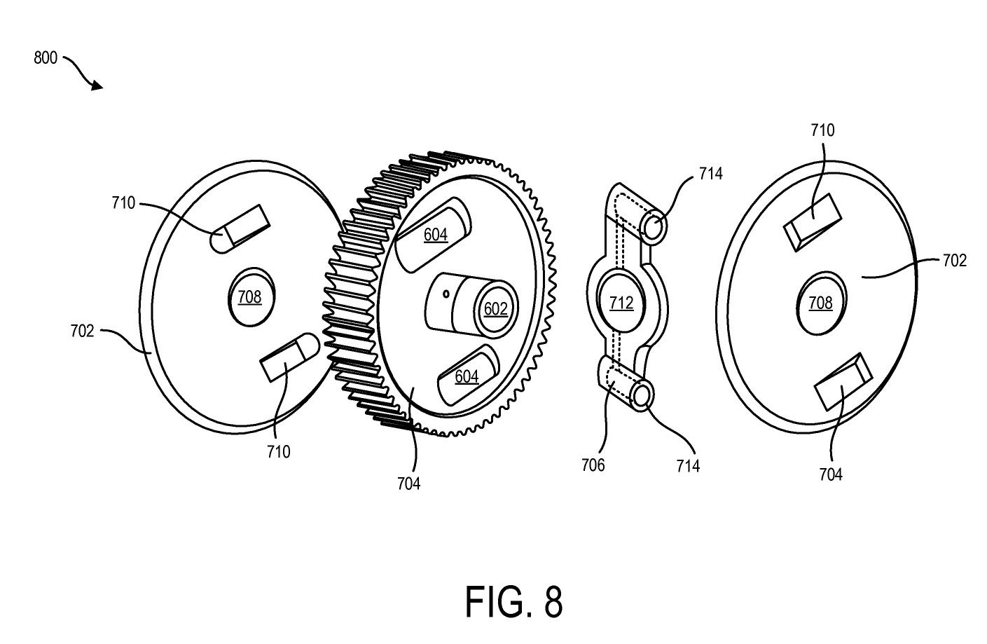

FIG. 6 shows an example of a gear assembly 600 consistent with implementations of the current subject matter. As shown in the exploded side view 700 of FIG. 7 and the exploded isometric view 800 of FIG. 8, the gear assembly 600 can optionally include opposing scissor parts 702, a main gear part 704, and a lifter carrier 706. The gear assembly 600 can include a hub 602, which can be part of the main gear 704 and can pass through corresponding openings 708 in the opposing scissor parts 702. The opposing scissor parts 702 can include tabs 710, which can pass into gaps 604 in the main gear part 704. The two opposing scissor parts 702 can optionally be identical (e.g. having a same catalog part number) but faced in opposite direction on opposite sides of the main gear part 704. This gear assembly 600 is an example of the assembly of main gear B and scissor gears B1 and B2 as discussed above in reference to FIG. 1B.

A center bore 712 of the lifter carrier 706 allows one or more drillings, which can be necessary to feed oil to a hydraulic backlash adjuster or piston 410, without resulting in an abnormally wide gear assembly. If one or more hydraulic backlash adjusters or pistons 410 are positioned underneath the gear rack, for example as might be desired from general packaging, the drilling to feed it as well as the bore that the hydraulic backlash adjuster or piston 410 rides in would have to pass through the gear teeth. Use of a lifter carrier 706 as in FIG. 7 and FIG. 8 can avoid the need to position a hydraulic backlash adjuster or piston 410 inboard or outboard of the axial end of the gear rack.

The lifter carrier 706 can include oil supply drillings to bring oil up from the hub 602 to one or more hydraulic lift adjuster elements or pistons 410 (not shown in FIG. 7 or FIG. 8) loaded into the bores 714 formed in the lifter carrier 706, for example at or near its outer edges. These bores 714 can be positioned to align the hydraulic lift adjuster elements or pistons 410 with the tabs 710 on the scissor gears 702. The positioning of the bores 714 in the lifter carrier 706 and the tabs 710 can be such that a clearance gap in a hydraulic lift adjuster element or piston 410 mounted in the bore 714 is at a smallest radius relative to the axis of the main gear 704. This positioning can ensure that centrifugal force of the gear movement pushes oil in the hydraulic lift adjuster element or piston 410 to the larger radius to leave a leak path for escape of any trapped air. The lifter carrier 706 can generally place the one or more hydraulic lift adjuster elements or pistons 410 in the same plane as the main gear 704 while the tabs 710 on the scissor gears 702 can reach into the same main gear slot 604 to be able to contact the hydraulic lift adjuster (HLA). A tab 710 on a first of the scissor gears 702 can contact one end of the hydraulic lift adjuster element or piston 410 while a tab 710 on the other scissor gear 702 can contact the opposite end of the hydraulic lift adjuster element or piston 410. The ends of the hydraulic lift adjuster element or piston 410 assembly can optionally be slightly crowned so that loads transmitted from the scissor gears 702 are applied as near as possible to a centerline of the hydraulic lift adjuster element or piston 410.

In some implementations of the current subject matter, a hydraulic lift adjuster element or piston 410 can advantageously include a small hydraulic volume and a check valve that is positioned very close to the applied load. While oil is generally considered to be incompressible, some structures used in conjunction with the current subject matter may require consideration of tolerances and the relatively small but not negligible compressibility of the hydraulic fluid (e.g. oil). Additionally, in some implementations of the current subject matter, angular rotation available to load a hydraulic lift adjuster element or piston 410 can be quite small. Preloading of the hydraulic lift adjuster element or piston 410 can be advantageous in some examples, as can positioning the hydraulic lift adjuster element or piston 410 at a position of largest possible expected motion. In addition, in some implementations of the current subject matter, the hydraulic lift adjuster element or piston 410 can be actuated bi-directionally, such as in order to adjust the positioning of one or more scissor gears.

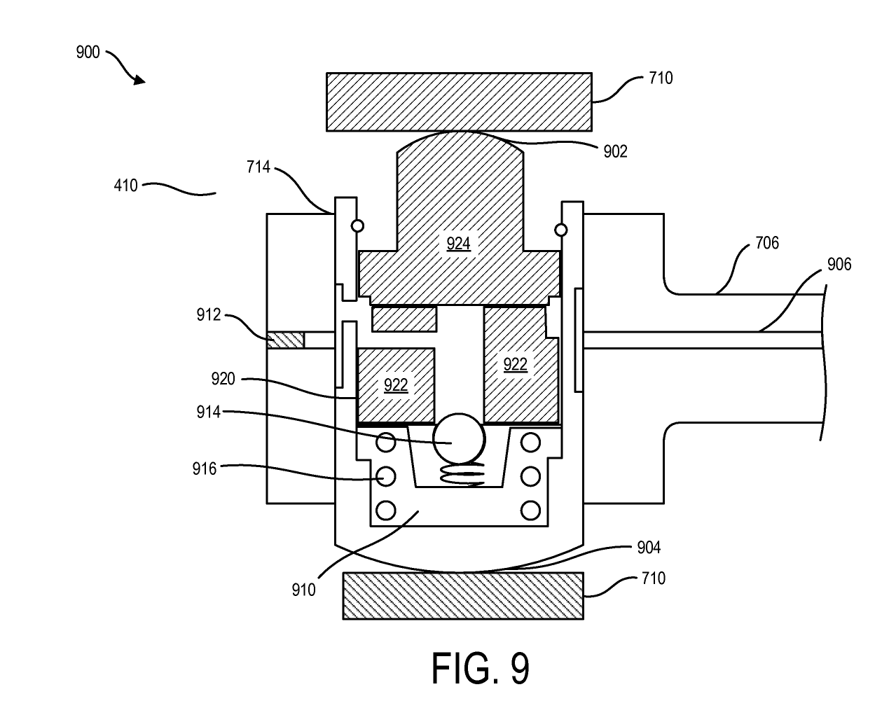

FIG. 9 shows a side cross sectional view 900 of a hydraulic lash adjuster element 410 that can be used in conjunction with various implementations of the current subject matter including the example illustrated in FIG. 6 through FIG. 8. As shown in FIG. 11, the hydraulic lash adjuster element 410 can be positioned with a first end 902 contacting a first tab 710 of a first scissor gear and an opposite end 904 contacting a second tab of a second scissor gear 710. The hydraulic lash adjuster element 410 itself can be mounted in one of the bores 714 of the lifter carrier 706. The curvature on the ends 902, 904 of the hydraulic lash adjuster element 410 can assist in minimizing the tendency of side forces to act on the hydraulic lash adjuster element 410 as the distance changes and the angle of the tabs 710 changes relative to the lifter carrier 706. Also as shown in FIG. 9, an oil supply channel 906 can be provided in the body of the lifter carrier 706.

Oil can be delivered into an oil reservoir 910 of the hydraulic lash adjuster element 410 to react the load on the hydraulic lash adjuster element 410. An oil plug 912 can be included on an outer side of the bore 714 in the lifter carrier 706 to prevent oil from escaping from a channel that can be created by boring in through the outer end of the lifter carrier 706 transversely through the bore 714. A check valve of the hydraulic lash adjuster element 410 can include a ball 914 urged by a spring 916 or other mechanism against an oil channel 920 to close the oil channel 920. The volume of the oil reservoir 910 can advantageously be as small as possible. In some examples, the volume of the oil channel 920 can be reduced by inclusion of one or more solid filler parts 922. A diameter of a piston 924 of the hydraulic lash adjuster element 410 and an oil supply pressure can determine a magnitude of the preload on the hydraulic lash adjuster element 410.

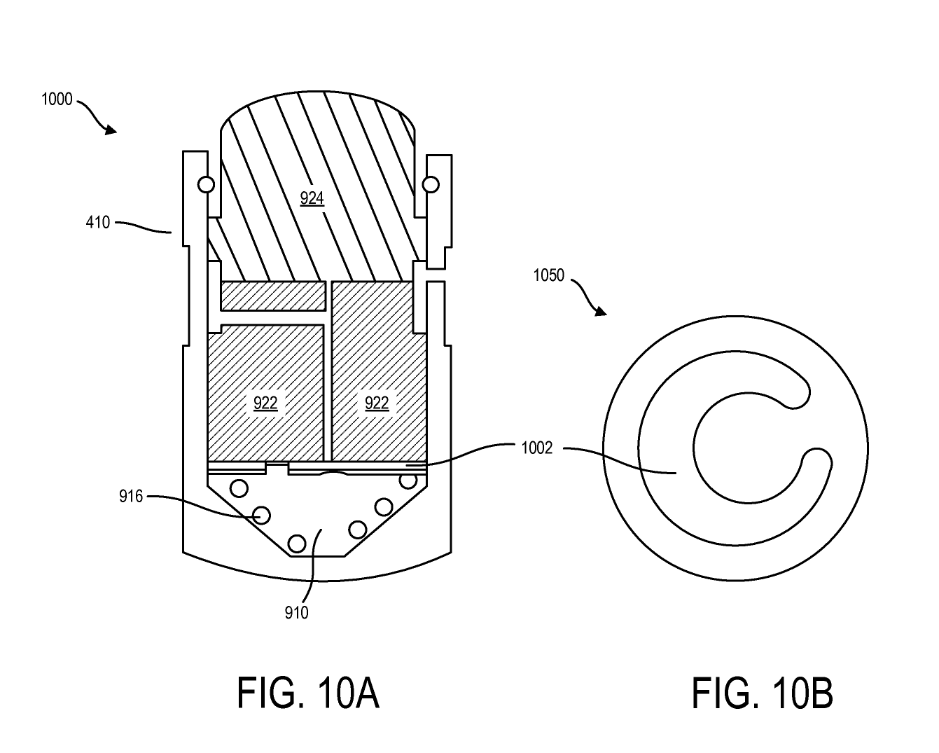

FIG. 10A and FIG. 10B show a side cross section view 1000 and a top cross section view 1050 of a check valve arrangement that can optionally be included in implementations of the current subject matter. The hydraulic lash adjuster element 410 of FIG. 9 can in some examples be susceptible to the check valve ball 914 being lifted off of its seat at the oil channel 920 by centrifugal force of the gear. To counteract this effect, the spring 916 can be required to be heavier to preload the ball 914 against the seat. In turn, a higher oil pressure can be required to lift the ball 914 and fill the oil reservoir 910 at low speed. The hydraulic lash adjuster element 410 shown in FIG. 10A and FIG. 10B can include a check valve formed of a relatively simpler flapper valve 1002 that is minimally affected by centrifugal loads on the hydraulic lash adjuster element 410. In some implementations of the current subject matter, the flapper 1002 can also optionally be made from spring steel, and can also act as the spring 916 that preloads the check valve to be closed.

FIG. 11 shows an example of a gear assembly 900 including a main gear 704 and a single scissor gear 1104 mounted on a common hub 602 of the main gear 704. One or more hydraulic lash adjusters or pistons 410 are mounted on spokes of the scissor gear 1104 but can also, optionally, be located in the main gear 704. While FIG. 9 shows two hydraulic lash adjusters 410, other numbers of hydraulic lash adjusters 410 are within the scope of the current subject matter. A hydraulic lash adjuster 410 can include a piston or similar structure acted on by hydraulic fluid in a reservoir 202 and positioned to apply a force against spoke of the main gear 704. The spokes of the main gear upon which the hydraulic lash adjuster 410 or piston acts can optionally include a reinforced or thickened area 1108. Fluid for creating a pressure and activating the hydraulic lash adjuster 410 can travel through a part of the scissor gear 1104, for example through a spoke of the scissor gear 1104.

De-aeration of the system through a bleed can also be implemented to ensure the hydraulic volume does not store air that could lead to reduced hydraulic system stiffness. As shown in FIG. 11, de-aeration of the system can occur through one or more bleed holes 1110, which can optionally be positioned at or near the hub 602. Overly low hydraulic system stiffness can enable negative torque to open backlash between teeth of the scissor gear 1104 and main gear 704, which can result in hammering or rattle noise. As noted in the descriptions above relating to some example implementations of the current subject matter, oil can be delivered into a grove (not shown) in the hub 602 of the main gear 704. This area can be vented through the rolling elements of the bearings, which can provide a centrifugal de-aeration of the oil before it enters into the supply reservoir 202 for a hydraulic backlash adjuster element or piston 410.

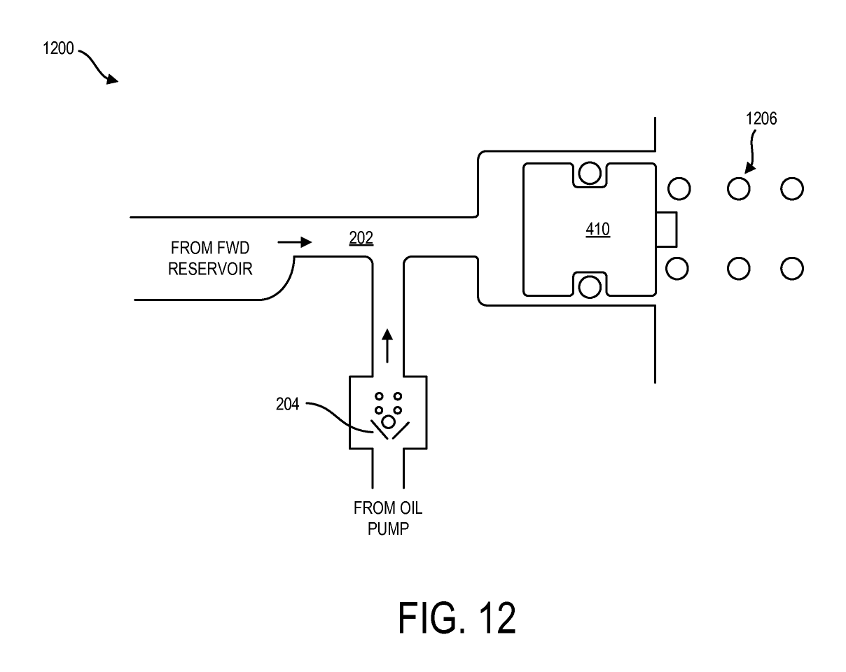

FIG. 12 shows an example of a hydraulic pressure supply 1200 usable in conjunction with a hydraulic backlash adjuster element or piston 410 such as those described herein. Oil or other fluid can be supplied through a check valve 204 into a fluid reservoir 202 that is acted upon by a piston or plunger 410. Movement of the piston or plunger 410, and hence system pressure, can be caused by one or more of a static spring 1206, an electronically controlled solenoid (not shown in FIG. 12), a cam apparatus (e.g. as shown in FIG. 3 and FIG. 4), or the like. Combinations of two or more approaches, such as for example an engine control unit-controlled solenoid with a spring, etc., are also within the scope of the current subject matter.

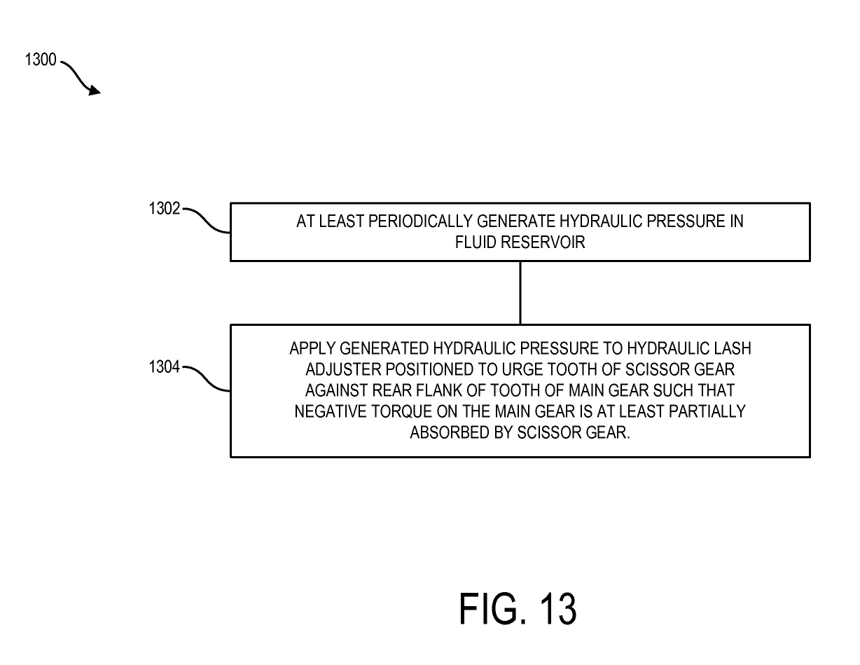

FIG. 13 shows a process flow chart 1300 illustrating features of a method consistent with implementations of the current subject matter. At 1302, hydraulic pressure is at least periodically generated, for example in a fluid reservoir. This generation of hydraulic pressure is one illustrative example of actuating a biasing apparatus, which can optionally include a hydraulic biasing member. The biasing apparatus can be disposed to act on a scissor gear that includes a third gear tooth (e.g. a scissor gear tooth) of a plurality of third gear teeth (e.g. a plurality of scissor gear teeth) and which can be positioned to rotate about a first axis.

The at least periodically generated hydraulic pressure can be applied at 1304 to a hydraulic lash adjuster positioned to urge a tooth of a scissor gear against a rear flank of a tooth of a main gear such that negative torque on the main gear is at least partially absorbed by the scissor gear. In other words, as a result of the actuating, which can involve increasing hydraulic pressure, an urging of the third gear tooth toward a second gear tooth of a plurality of second gear teeth of a second gear can be caused. This urging can close a backlash gap between a first gear tooth of a plurality of first gear teeth of a main gear and the second gear tooth of the second gear. The main gear can be positioned to rotate about the first axis and the second gear can be positioned to rotate about a second axis, which can optionally be parallel to the first axis.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

1. A gear assembly comprising:
a main gear comprising a first gear tooth of a plurality of first gear teeth and positioned to rotate about a first axis;
a second gear comprising a second gear tooth of a plurality of second gear teeth, the second gear positioned to rotate about a second axis such that the plurality of second gear teeth mesh with the plurality of first gear teeth;
a scissor gear comprising a third gear tooth of a plurality of third gear teeth and positioned to rotate about the first axis; and
a biasing apparatus disposed to selectively urge the third gear tooth of the scissor gear toward the second gear tooth of the second gear, the selectively urging closing a backlash gap between the first gear tooth and the second gear tooth when the biasing apparatus is actuated, the biasing apparatus comprising a hydraulic biasing member.

2. The gear assembly of claim 1, further comprising a fluid pathway in fluid communication with the hydraulic biasing member, wherein actuation of the biasing apparatus comprises increasing fluid pressure in the fluid pathway.

3. (canceled)

4. The gear assembly of claim 2, further comprising a pressure adjusting element in communication with the fluid pathway, the pressure adjusting element causing the increase and a subsequent decrease in fluid pressure in response to rotation of the scissor gear about the first axis.

5. The gear assembly of claim 1, wherein the selectively urging occurs when the gear assembly is under a negative load.

6. The gear assembly of claim 1, wherein the hydraulic biasing member comprises a piston.

7. The gear assembly of claim 1, further comprising a spring that is positioned to assist with opening or closing the backlash gap between the first gear tooth and the second gear tooth.

8. The gear assembly of claim 1, further comprising a lifter carrier having a fluid pathway that is in fluid communication with the hydraulic biasing member, with the biasing apparatus being secured to the lifter carrier.

9. The gear assembly of claim 8, wherein the scissor gear comprises a tab that extends through a gap in the main gear, the tab being positioned to allow the hydraulic biasing member to selectively urge against the tab.

10. The gear assembly of claim 1, further comprising one or more of a static spring, an electronically controlled solenoid, and a cam apparatus that selectively urges the biasing apparatus.

11. The gear assembly of claim 1, further comprising a second biasing apparatus comprising a second hydraulic biasing member disposed to selectively urge a fourth gear tooth of a second scissor gear toward a fifth gear tooth of a third gear, the selectively urging closing a backlash gap between the fourth gear tooth and the fifth gear tooth when the second biasing apparatus is activated.

12. The gear assembly of claim 1, wherein the biasing apparatus is disposed to selectively urge a fourth gear tooth of a second scissor gear toward a fifth gear tooth of a third gear, the biasing apparatus being actuated bi-directionally and the selectively urging closing a backlash gap between the fourth gear tooth and the fifth gear tooth when the biasing apparatus is actuated.

13. (canceled)

14. (canceled)

15. A method comprising:
actuating a biasing apparatus disposed to act on a scissor gear, the scissor gear comprising a third gear tooth of a plurality of third gear teeth and positioned to rotate about a first axis; and
causing, as a result of the actuating, an urging of the third gear tooth toward a second gear tooth of a plurality of second gear teeth of a second gear, thereby closing a backlash gap between a first gear tooth of a plurality of first gear teeth of a main gear and the second gear tooth of the second gear, wherein the main gear is positioned to rotate about the first axis and the second gear is positioned to rotate about a second axis.

16. The method of claim 15, wherein the biasing apparatus comprises a hydraulic biasing member, and the actuating comprises increasing fluid pressure in a fluid pathway that is in fluid communication with the hydraulic biasing member.

17. The method of claim 16, wherein the biasing apparatus experiences a second condition subsequent to being actuated, the second condition comprising a decrease in fluid pressure in the fluid pathway that allows opening of the backlash gap.

18. The method of claim 17, further comprising increasing and decreasing the fluid pressure in response to rotation of the scissor gear about the first axis.

19. The method of claim 15, wherein the urging occurs when a gear assembly comprising the main gear, the scissor gear, and the second gear is under a negative load.

20. (canceled)

21. The method of claim 15, further comprising assisting in opening and/or closing of the backlash gap between the first gear tooth and the second gear tooth, the assisting comprising acting on the scissor gear with a spring.

22. (canceled)

23. (canceled)

24. The method of claim 15, further comprising controlling the selective urging of the biasing apparatus by one or more of a static spring, an electronically controlled solenoid, and a cam apparatus.

25. The method of claim 15, further comprising activating a second biasing apparatus comprising a second hydraulic biasing member disposed to selectively urge a fourth gear tooth of a second scissor gear toward a fifth gear tooth of a third gear, the selectively urging closing a backlash gap between the fourth gear tooth and the fifth gear tooth when the second biasing apparatus is activated.

26. The method of claim 15, further comprising activating the biasing apparatus disposed to selectively urge a fourth gear tooth of a second scissor gear toward a fifth gear tooth of a third gear, the biasing apparatus being actuated bi-directionally and the selectively urging closing a backlash gap between the fourth gear tooth and the fifth gear tooth when the biasing apparatus is actuated.

27. (canceled)

28. (canceled)
